(19) United States
(12) Patent Application Publication
(10) Pub. No.: US 2020/0230658 A1
(43) Pub. Date: Jul. 23, 2020

(54) CLEANING TOOL WITH DEDICATED WATER AND DETERGENT CONDUITS

(71) Applicant: IMPAX MARKETING LLC, Portland, OR (US)

(72) Inventor: Ryan NEAL, Portland, OR (US)

(21) Appl. No.: 16/742,294

(22) Filed: Jan. 14, 2020

Related U.S. Application Data
(60) Provisional application No. 62/794,026, filed on Jan. 18, 2019.

(51) Int. Cl. B08B 3/02; B08B 1/00; B05B 9/04

(52) U.S. Cl. CPC B08B 3/026; B08B 1/002; B08B 2203/0205; B08B 2203/0217; B05B 9/04

(57) ABSTRACT

A representative cleaning tool includes: a valve assembly having an inlet, a first outlet, a second outlet and an actuator, the inlet configured to receive a flow of water, the first outlet fluidly communicating with a first conduit, the second outlet fluidly communicating with a second conduit, and the actuator configured to selectively direct the flow of water from the inlet based on a position of the actuator; a mixing assembly fluidly communicating with the second conduit; a detergent reservoir fluidly communicating with the mixing assembly and configured to receive therein a supply of detergent, wherein, based on the actuator being in the second position, the valve assembly directs the flow of water to the mixing assembly, which draws a portion of the supply of detergent from the detergent reservoir and mixes the water and the detergent to form foam that is directed through the second conduit; and a handle configured to be gripped by a hand of a user, wherein the actuator is configured to be moved by the hand of the user while gripping the handle.

### CROSS REFERENCE TO RELATED APPLICATION

This utility application claims the benefit of and priority to U.S. Provisional Application 62/794,026, filed on 18 Jan. 2019, which is incorporated herein by reference in its entirety.

### BACKGROUND

### Technical Field

The disclosure generally relates to cleaning tools.

### Description of the Related Art

Various cleaning devices are available that incorporate features for facilitating cleaning. By way of example, some of these devices incorporate brushes that are relatively efficient for use in washing an item that is to be cleaned. Additionally, some of these devices incorporate provisions for rinsing an item, such as is provided by the wand of a pressure washer. Unfortunately, conventional cleaning devices often fail to provide efficient solutions for both washing and rinsing in a single device that is easy to operate. For instance, some solutions may require the use of one cleaning device for washing and another for rinsing. As another example, some solutions may involve the use of a single device for performing both washing and rinsing functions; however, changing from one function to the other tends to involve reconfiguration of the cleaning device that requires repositioning of the user's hands on the cleaning device and/or the use of tools.

Therefore, it is desirable to provide a cleaning device that addresses the aforementioned perceived needs.

### SUMMARY

An example embodiment of a cleaning tool, comprises: a body having a proximal end, a distal end, a first conduit extending from the proximal end to the distal end and a second conduit extending from the proximal end to the distal end; a valve assembly disposed at the proximal end of the body, the valve assembly having an inlet, a first outlet, a second outlet and an actuator, the inlet being configured to receive a flow of water, the first outlet fluidly communicating with the first conduit, the second outlet fluidly communicating with the second conduit, and the actuator being configured to selectively direct the flow of water from the inlet based on a position of the actuator, the actuator having an OFF position, at which the flow of water is prevented from flowing into both the first conduit and the second conduit, a first position, at which the flow of water is selectively directed to flow into the first conduit, and a second position, at which the flow of water is selectively directed to flow into the second conduit; a mixing assembly fluidly communicating with the second conduit; a detergent reservoir fluidly communicating with the mixing assembly and configured to receive therein a supply of detergent, wherein, based on the actuator being in the second position, the valve assembly directs the flow of water to the mixing assembly, which draws a portion of the supply of detergent from the detergent reservoir and mixes the water and the detergent to form foam that is directed through the second conduit; and a handle positioned at the proximal end of the body and configured to be gripped by a hand of a user, wherein the actuator is configured to be moved to a selected one of the OFF position, the first position and the second position by the hand of the user while gripping the handle.

In some embodiments, the handle is operatively engaged with the valve assembly and configured to be moved, relative to the body, to selectively position the actuator.

In some embodiments, the handle is rotatable, relative to the body, to selectively position the actuator.

In some embodiments, the first conduit extends in parallel with respect to a first longitudinal axis; the handle is rotatable about a second longitudinal axis; and the first longitudinal axis and the second longitudinal axis are not parallel to each other.

In some embodiments, the actuator has a switch mounted exterior of the handle that is configured to be moved to a selected one of the OFF position, the first position and the second position by a thumb of the hand of the user while the hand grips the handle.

In some embodiments, the handle has a connector configured to engage a water supply conduit for providing the flow of water.

In some embodiments, a water flow control assembly is configured to selectively direct the flow of water received at the handle to the valve assembly.

In some embodiments, a spray nozzle is disposed at a distal end of the first conduit.

In some embodiments, the spray nozzle is removable.

In some embodiments, a brush head is disposed at a distal end of the second conduit.

In some embodiments, the brush head is removable.

In some embodiments, the brush head is pivotable.

In some embodiments, a mounting aperture is configured to mount the cleaning tool to a mounting surface with the brush head facing away from the mounting surface so that the brush head does not contact the mounting surface.

In some embodiments, the mounting aperture is defined by a mounting recess formed in the handle.

In some embodiments, the mixing assembly has a siphoning apparatus extending into the detergent reservoir.

In some embodiments, the siphoning apparatus has a siphoning conduit with a distal conduit end configured to extend into the detergent reservoir and self-orient to a low portion of the detergent reservoir to draw the detergent from the low portion.

In some embodiments, the mixing assembly has a baffle assembly, downstream of the siphoning apparatus, configured form the foam.

In some embodiments, the detergent reservoir is removable.

Other objects, features, and/or advantages will become apparent from the following detailed description of the preferred but non-limiting embodiments. The following description is made with reference to the accompanying drawings.

### BRIEF DESCRIPTION OF THE DRAWINGS

FIG. 1 is a schematic diagram of an embodiment of a cleaning tool.

FIG. 2 is a schematic diagram of the embodiment of FIG. 1.

FIG. 3A is a schematic diagram of an embodiment with a valve actuator in the OFF position and showing a tool-mounting aperture.

FIG. 3B is a schematic diagram of an embodiment of a valve assembly corresponding to the OFF position of FIG. 3A.

FIG. 3C is a schematic diagram of an embodiment of the first and second conduits when the valve assembly is in the OFF position of FIG. 3B.

FIG. 4A is a schematic diagram of the embodiment of FIG. 3A with the valve actuator in the SPRAY position.

FIG. 4B is a schematic diagram of the embodiment of the valve assembly of FIG. 3B corresponding to the OFF position of FIG. 4A.

FIG. 4C is a schematic diagram of an embodiment of the first and second conduits when the valve assembly is in the SPRAY position of FIG. 4B.

FIG. 5A is a schematic diagram of the embodiment of FIGS. 3A and 4A with the valve actuator in the FOAM position.

FIG. 5B is a schematic diagram of the embodiment of the valve assembly of FIGS. 3B and 4B corresponding to the FOAM position of FIG. 5A.

FIG. 5C is a schematic diagram of an embodiment of the first and second conduits when the valve assembly is in the FOAM position of FIG. 5B.

FIG. 6 is a schematic diagram showing detail of an embodiment of a mixing assembly and associated detergent reservoir.

FIG. 7 is a schematic diagram of another embodiment of a cleaning tool.

FIG. 8 is a schematic diagram showing detail of an embodiment of a valve actuator.

FIG. 9 is a schematic diagram showing detail of an embodiment of a tool-mounting aperture.

### DETAILED DESCRIPTION

For ease in explanation, the following discussion describes several embodiments of a cleaning tool with dedicated water and detergent conduits. It is to be understood that the invention is not limited in its application to the details of the particular arrangements shown since the invention is capable of other embodiments. Also, the terminology used herein is for the purpose of description and not of limitation.

In this regard, various cleaning tools are provided that are designed for increased control and efficiency for washing automobiles, motorcycles, recreational vehicles, boats, and the like. In some embodiments, improved control and efficiency is provided by incorporating dedicated conduits, one of which provides a primary route for water and the other of which provides a primary route for foam formed of water and detergent. In some embodiments, the detergent is supplied by a reservoir carried by the cleaning tool. Embodiments may also incorporate a multi-function valve assembly that is configured to be adjusted in response to actuation by the hand of a user while that hand is gripping a handle of the cleaning tool.

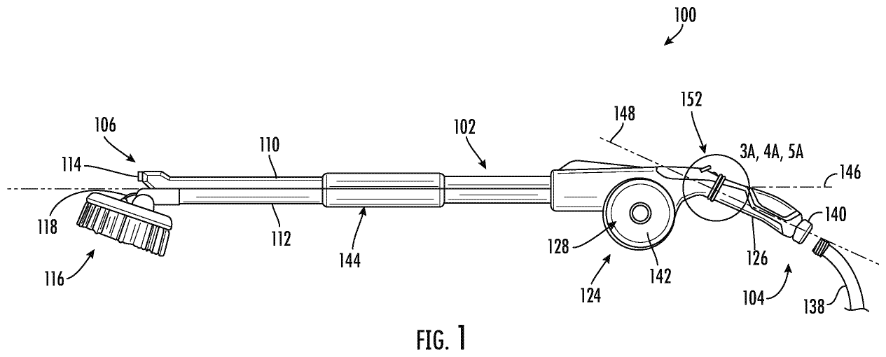

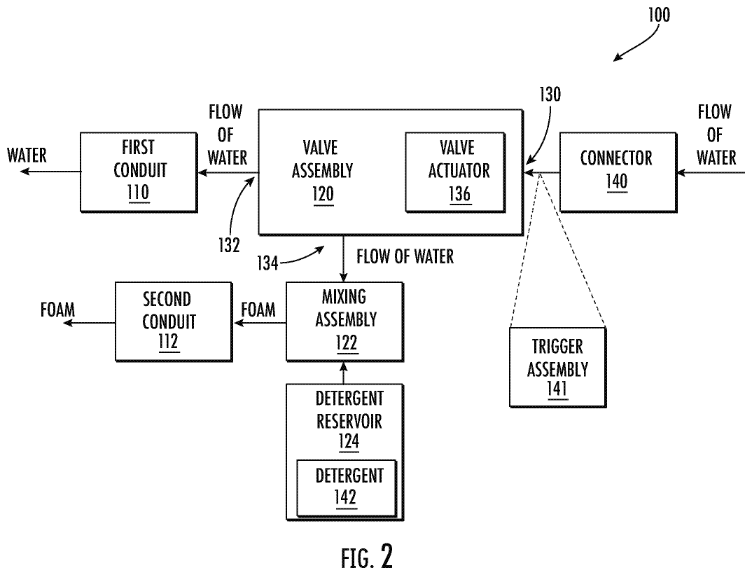

FIGS. 1 and 2 depict an embodiment of a cleaning tool 100, which (as best shown in FIG. 1), incorporates a body 102 that extends between a proximal end 104 and a distal end 106. Body 102 includes first and second conduits (e.g., tubes) 110, 112, both of which extend from proximal end 104 to distal end 106. In some embodiments, an outer sheath (e.g., a sheath formed of plastic or metal) may be provided, within which is disposed at least a portion of each of the two separate conduits. In this embodiment, a spray nozzle 114 is disposed at a distal end of first conduit 110 and a brush head 116 is disposed at a distal end of second conduit 112. In some embodiments, either or both of spray nozzle 114 and brush head 116 may be adjustable and/or removable. By way of example, a spray nozzle may be adjustable in order to provide a range of output spray patterns and/or force of water flow. As another example, a brush head may be movable (e.g., pivotable) with respect to the body to better conform to the exterior surface of the item being cleaned. In some embodiments, the brush head may be configured to receive therethrough a flow of foam output from the second conduit, such as via a flexible conduit segment 118 that interconnects the second conduit and the brush head.

Cleaning tool 100 also includes a valve assembly 120, a mixing assembly 122, a detergent reservoir 124 and a handle 126. Valve assembly 120 is disposed at proximal end 104 and incorporates an inlet 130, a first outlet 132, a second outlet 134 and a valve actuator 136. Inlet 130 is configured to receive a flow of water from a water supply conduit 138 (for example, a garden hose or pressurized conduit, such as that associated with a pressure washer). In some embodiments, connection to a water supply conduit may be facilitated by a connector 140 disposed at distal end 106 that mates with a corresponding connector of the water supply conduit.

Additionally, in some embodiments, a trigger assembly 141 is provided downstream of connector 140 to facilitate selective disruption/continuity in the flow of water through the cleaning tool. In particular, trigger assembly 141 (water flow control assembly) may selectively direct the flow of water to the valve assembly when in a FLOW position and may selectively prevent the flow of water to the valve assembly when in a NO-FLOW position.

First outlet 132 fluidly communicates with first conduit 110 (see, FIG. 2) to provide a flow of water to first conduit 110 when so directed by valve actuator 136. Similarly, second outlet 134 fluidly communicates with second conduit 112 to provide a flow of water to second conduit 112 when so directed by valve actuator 136. Valve assembly 120 is configured to selectively direct the flow of water from inlet 130 based on a position of valve actuator 136. Specifically, in some embodiments, valve actuator 136 defines an OFF position, a first position and a second position. In the OFF position, valve assembly 120 prevents the flow of water from flowing into conduits 110 and 112. In the first position, valve assembly 120 selectively directs the flow of water into first conduit 110, whereas, in the second position, valve assembly 120 selectively directs the flow of water into second conduit 112.

Mixing assembly 122 fluidly communicates with second conduit 112 and is configured to provide foam (i.e., a mixture of detergent, water and air) for use in cleaning via second conduit 112. In particular, detergent reservoir 124 fluidly communicates with mixing assembly 122 (see, FIG. 2) and is configured to receive a supply of detergent 142. In some embodiments, detergent reservoir 124 may be removable, with a range of sizes being provided. So configured, a detergent reservoir of appropriate detergent capacity may be selectively attached to body 102. Additionally, detergent reservoir 124 may be configured to be externally fillable. In some embodiments, detergent reservoir 124 incorporates a detergent-level indicator 128 (e.g., a transparent portion of detergent reservoir 124) so that the level of detergent in detergent reservoir 124 is visible to the user.

When valve actuator 136 is in the second position, valve assembly 120 directs the flow of water to mixing assembly 122, which draws a portion of the supply of detergent from detergent reservoir 124 and mixes the water, detergent and any entrained air to form foam that is directed through second conduit 112.

Handle 126 is positioned at proximal end 104 of cleaning tool 100. Handle 126 is configured to be gripped by a hand of a user during use of the cleaning tool. Additionally, a fore grip 144 is provided between mixing assembly and distal end 106 to provide a suitable location for gripping by the user's other hand. In some embodiments, handle 126 and/or fore grip 144 may be formed of a non-slip (e.g., vinyl) material.

Valve actuator 136 is configured to be moved between the OFF position, the first position and the second position by the hand of the user while the user maintains a grip about the handle. In this embodiment, this is facilitated by handle 126 being operatively engaged with valve assembly 120 and configured to be moved, relative to body 102, to selectively position valve actuator 136. Thus, the user does not need to relinquish control of the handle at the proximal end of the cleaning tool while switching between the various actuator positions/cleaning functions.

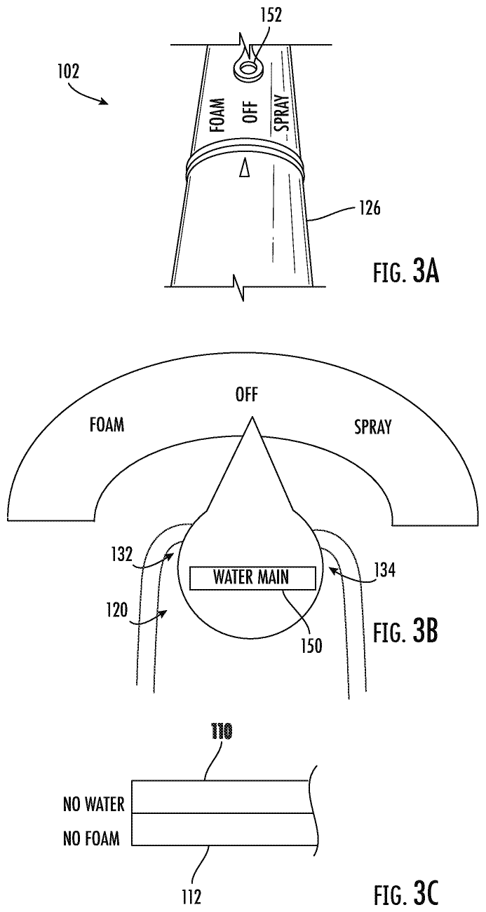

In some embodiments, handle 126 is rotatable, relative to body 102, to selectively position valve actuator 136. In some of these embodiments, first conduit 110 extends in parallel with respect to a first longitudinal axis 146 and handle 126 is rotatable about a second longitudinal axis 148, which is not parallel with first longitudinal axis 146. Configurations that incorporate this offset feature may provide improved ergonomics compared to embodiments that incorporate an in-line handle configuration. Operation of handle 126 for positioning valve actuator 136 is depicted in FIGS. 3A-3C, 4A-4C and 5A-5C.

As shown in FIG. 3A, handle 126 is in a position that corresponds to the OFF position of valve actuator 136 (FIG. 3B). Note that, in this embodiment, body 102 exhibits position markings and body 102 incorporates a corresponding indexing mark. In the OFF position, a main water source 150 of valve assembly 120 is disconnected from first outlet 132 and second outlet 134. Thus, a flow of water provided to valve assembly 120 is prevented from flowing into conduit 110 or 112 (see, FIG. 3C). Note also in FIG. 3A that a tool-mounting aperture 152 is depicted. In this embodiment, tool-mounting aperture 152 protrudes outwardly from an exterior surface of body 102. Tool-mounting aperture 152 is configured to mount cleaning tool 100 to a mounting surface (e.g., a vertical wall) so that brush head 126 faces away from the mounting surface to prevent water and/or detergent that remains on the brush head from coming in contact with the mounting surface. In some embodiments, the tool-mounting aperture may be retractable so as to not protrude from body 102 during use of the cleaning tool.

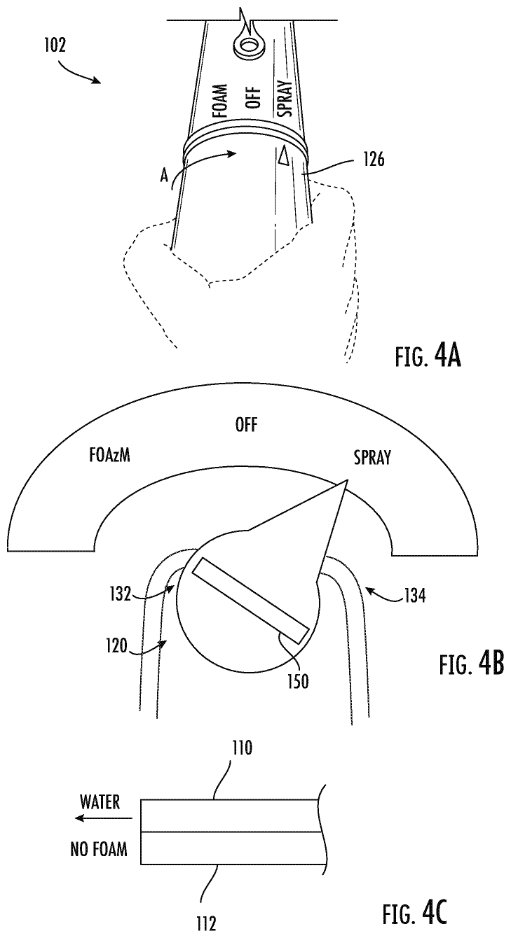

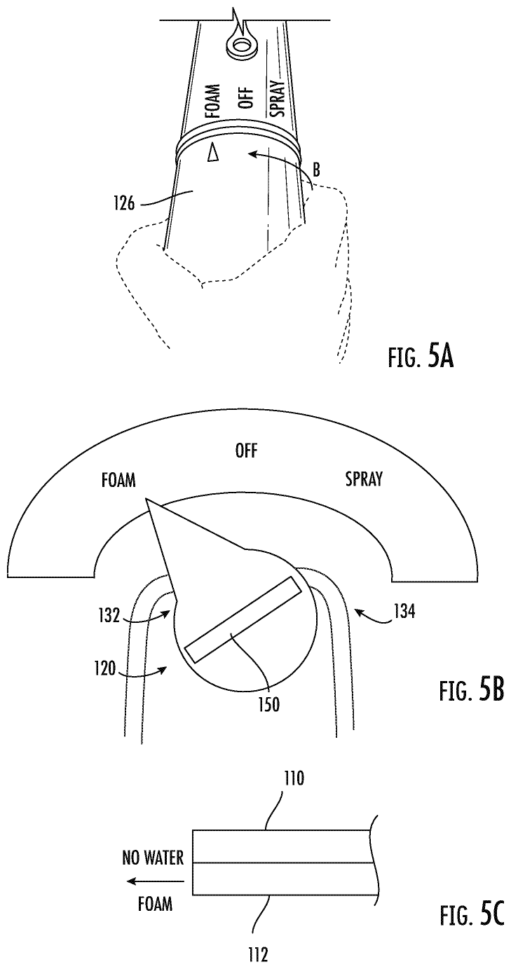

When handle 126 is rotated in the direction indicated by arrow A in FIG. 4A, handle 126 assumes the first (SPRAY) position. As shown in FIG. 4B, when in the first position, main water source 150 is connected to first outlet 132 so that valve assembly 120 selectively directs the flow of water into first conduit 110 (see, FIG. 4C). Then, when handle 126 is rotated in the direction indicated by arrow B in FIG. 5A, handle 126 assumes the second (FOAM) position. As shown in FIG. 5B, when in the second position, main water source 150 is connected to second outlet 134 so that valve assembly 120 selectively directs the flow of water into second conduit 112 (see, FIG. 5C).

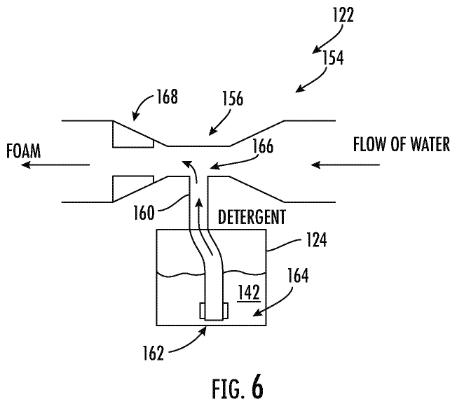

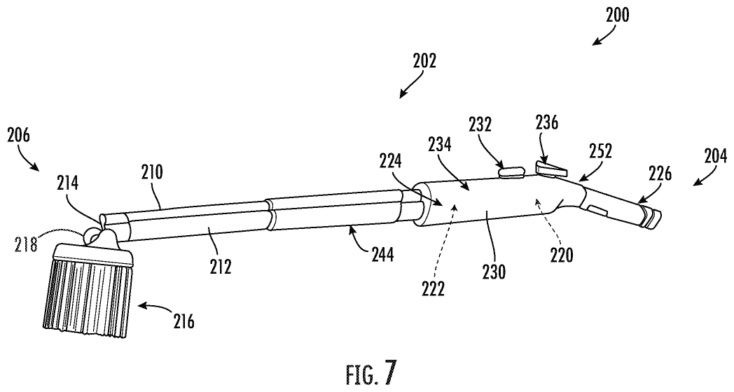

FIG. 6 is a schematic diagram showing detail of an embodiment of a mixing assembly and associated detergent reservoir. As shown in FIG. 6, mixing assembly 122 includes a siphoning apparatus 154 that is configured to draw detergent from detergent reservoir 124. Specifically, siphoning apparatus 154 incorporates a low pressure flow portion 156 and a siphoning conduit 160. Low pressure flow portion 156 is configured to reduce a localized pressure within mixing assembly 122 for drawing detergent out of detergent reservoir 124. Siphoning conduit 160, which may be formed of a length of flexible tubing, for example, includes a distal conduit end 162 that is configured to extend into the detergent reservoir. Of note, siphoning conduit 160 is configured to self-orient to a low portion 164 of detergent reservoir 124 to draw detergent from low portion 164. In some embodiments, this may be accomplished by weighting distal conduit end 162 so that siphoning conduit 160 hangs predominantly in the plumb position regardless of the orientation of the cleaning tool.

A proximal conduit end 166 of siphoning conduit 160 fluidly communicates with low pressure flow portion 156 and is configured to deliver detergent into mixing assembly 122 when a flow of water of adequate volume and pressure is flowing through low pressure flow portion 156. Once in low pressure flow portion 156, the detergent mixes with the flow of water and is agitated by downstream baffle assembly 168, which creates foam from the water, detergent and air present.

To operate cleaning tool 100, a user typically would fill the detergent reservoir with an adequate supply of detergent and then attach the cleaning tool to a garden hose. The user may then adjust the valve assembly by using the actuator to set the cleaning tool to spray water onto the item that is to be cleaned. As described before, this may be done without releasing the user's grip on the cleaning tool. After adequate wetting, the user may adjust the valve assembly using the actuator to set the cleaning tool to apply foam to the item, after which the brush head may be used for scrubbing. A final adjustment may then be made to rinse the item with water before selecting the OFF position to discontinue the flow of water through the cleaning tool. Thereafter, the cleaning tool may be disconnected from the garden hose and stored, such as by hanging the cleaning tool from a mounting surface using the tool-mounting aperture.

FIG. 7 is a schematic diagram of another embodiment of a cleaning tool that does not incorporate the rotating handle design previously described. In particular, cleaning tool 200 utilizes an actuator that is readily positioned by the thumb of a user while the user grips the associated handle. As shown in FIG. 7, cleaning tool 200 incorporates a body 202 that extends between a proximal end 204 and a distal end 206. Body 102 includes first and second conduits 210 and 212. A spray nozzle 214 is disposed at a distal end of first conduit 210 and a brush head 216 is disposed at a distal end of second conduit 212, with a conduit segment 218 providing a flow passage between second conduit 212 and brush head 216.

Cleaning tool 200 also includes a valve assembly 220, a mixing assembly 222 and a detergent reservoir 224, with the various interconnections and operations of these components being generally internal to cleaning tool 200 and similar those shown and described with respect to the schematic diagram of FIG. 2. Significantly, the functions of the components of cleaning tool 200 may be similar to those of corresponding components of cleaning tool 100 unless otherwise noted herein.

By way of example, detergent reservoir 224 exhibits an integrated configuration with that of an outer sheath or cover plate 230 that generally surrounds valve assembly 220 and mixing assembly 222. Detergent reservoir 224 is externally fillable, such as via a removable filler cap 232, with a fill level of the detergent being viewable using a detergent-level indicator 234.

A handle 226 is positioned at proximal end 204 of cleaning tool 200. Handle 226 is configured to be gripped by a hand of a user during use of the cleaning tool. Additionally, a fore grip 244 is provided between cover plate 230 and distal end 206 to provide a suitable location for gripping by the user's other hand.

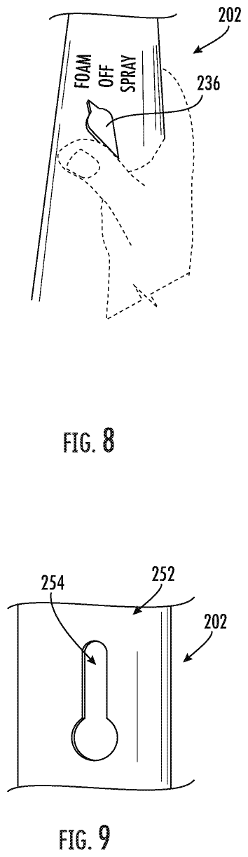

An actuator 236 also is provided that is configured to position valve assembly 220. As best shown in FIG. 8, actuator 236 is configured to be moved between an OFF position, a first position (e.g., a SPRAY position) and a second position (e.g., a FOAM position) by the hand of the user (e.g., by the user's thumb) while the user maintains a grip about handle 226. Thus, the user does not need to relinquish control of the proximal end of the cleaning tool while switching between the various actuator positions/cleaning functions.

FIG. 9 is a schematic diagram showing detail of an embodiment of a tool-mounting aperture. As shown in FIG. 9 (and FIG. 7), tool-mounting aperture 252 is configured to mount cleaning tool 200 to a mounting surface so that brush head 226 faces away from the mounting surface. In this embodiment, tool-mounting aperture 252 is defined by a mounting recess 254 formed in handle 226.

The embodiments described above are illustrative of the invention and it will be appreciated that various permutations of these embodiments may be implemented consistent with the scope and spirit of the invention.

I claim:

1. A cleaning tool, comprising:
a body having a proximal end, a distal end, a first conduit extending from the proximal end to the distal end and a second conduit extending from the proximal end to the distal end;
a valve assembly disposed at the proximal end of the body, the valve assembly having an inlet, a first outlet, a second outlet and an actuator, the inlet being configured to receive a flow of water, the first outlet fluidly communicating with the first conduit, the second outlet fluidly communicating with the second conduit, and the actuator being configured to selectively direct the flow of water from the inlet based on a position of the actuator, the actuator having an OFF position, at which the flow of water is prevented from flowing into both the first conduit and the second conduit, a first position, at which the flow of water is selectively directed to flow into the first conduit, and a second position, at which the flow of water is selectively directed to flow into the second conduit;
a mixing assembly fluidly communicating with the second conduit;
a detergent reservoir fluidly communicating with the mixing assembly and configured to receive therein a supply of detergent, wherein, based on the actuator being in the second position, the valve assembly directs the flow of water to the mixing assembly, which draws a portion of the supply of detergent from the detergent reservoir and mixes the water and the detergent to form foam that is directed through the second conduit; and
a handle positioned at the proximal end of the body and configured to be gripped by a hand of a user, wherein the actuator is configured to be moved to a selected one of the OFF position, the first position and the second position by the hand of the user while gripping the handle.

2. The cleaning tool of claim 1, wherein the handle is operatively engaged with the valve assembly and configured to be moved, relative to the body, to selectively position the actuator.

3. The cleaning tool of claim 2, wherein the handle is rotatable, relative to the body, to selectively position the actuator.

4. The cleaning tool of claim 3, wherein:
the first conduit extends in parallel with respect to a first longitudinal axis;
the handle is rotatable about a second longitudinal axis; and
the first longitudinal axis and the second longitudinal axis are not parallel to each other.

5. The cleaning tool of claim 1, wherein the actuator has a switch mounted exterior of the handle that is configured to be moved to a selected one of the OFF position, the first position and the second position by a thumb of the hand of the user while the hand grips the handle.

6. The cleaning tool of claim 1, wherein the handle has a connector configured to engage a water supply conduit for providing the flow of water.

7. The cleaning tool of claim 6, further comprising a water flow control assembly configured to selectively direct the flow of water received at the handle to the valve assembly.

8. The cleaning tool of claim 1, further comprising a spray nozzle disposed at a distal end of the first conduit.

9. The cleaning tool of claim 8, wherein the spray nozzle is removable.

10. The cleaning tool of claim 1, further comprising a brush head disposed at a distal end of the second conduit.

11. The cleaning tool of claim 10, wherein the brush head is removable.

12. The cleaning tool of claim 10, wherein the brush head is pivotable.

13. The cleaning tool of claim 10, further comprising a mounting aperture configured to mount the cleaning tool to a mounting surface with the brush head facing away from the mounting surface so that the brush head does not contact the mounting surface.

14. The cleaning tool of claim 13, wherein the mounting aperture is defined by a mounting recess formed in the handle.

15. The cleaning tool of claim 1, wherein the mixing assembly has a siphoning apparatus extending into the detergent reservoir.

16. The cleaning tool of claim 15, wherein the siphoning apparatus has a siphoning conduit with a distal conduit end configured to extend into the detergent reservoir and self-orient to a low portion of the detergent reservoir to draw the detergent from the low portion.

17. The cleaning tool of claim 15, wherein the mixing assembly has a baffle assembly, downstream of the siphoning apparatus, configured form the foam.

18. The cleaning tool of claim 1, wherein the detergent reservoir is removable.
